(19) United States
(12) Patent Application Publication
(10) Pub. No.: US 2003/0220840 A1
(43) Pub. Date: Nov. 27, 2003

(54) Electric vehicle power distribution network

(76) Inventors: Tushar Vashi, San Marcos, CA (US); Steve P. Hansen, Northville, MI (US); Michael G. Ellis, San Marcos, CA (US); Jeffrey A. Palic, Dearborn, MI (US)

Correspondence Address: DYKEMA GOSSETT PLLC, 39577 WOODWARD AVENUE, SUITE 300, BLOOMFIELD HILLS, MI, 48304, US

(21) Appl. No.: 10/358,019

(22) Filed: Feb. 3, 2003

Related U.S. Application Data
(60) Provisional application No. 60/353,316, filed on Feb. 1, 2002.

(51) Int. Cl. G06F 17/60

(52) U.S. Cl. 705/16

(57) ABSTRACT

An electric vehicle 28, 30 power distribution system 70 is provided which allows for a vehicle operator to acquire a fully charged battery 20/24.

This application claims the benefit of U.S. Provisional Application Serial No. 60/353316 filed Feb. 1, 2002.

### FIELD OF THE INVENTION

The field of the present invention is a power distribution network for electric vehicles. Specifically, the present invention relates to a power distribution network for electric vehicles, such as trucks, cars, motor scooters and/or electric bikes.

### BACKGROUND OF THE INVENTION

The need to reduce fossil fuel consumption and emissions in automobiles and other vehicles predominantly powered by an internal combustion engine is well known. Vehicles powered by electric motors attempt to address this need. Two of the biggest issues affecting the business viability of electric vehicles are their range and battery charging convenience.

Due to the physics involved, most electric vehicle batteries take hours to recharge. Often, the charging voltage and amperages required that are best suited for accomplishing the task are not provided in standard home electrical powered distribution systems.

### SUMMARY OF THE INVENTION

To meet the above-noted desire, a revelation of the present invention is brought forth. In its preferred embodiment, the present invention provides a network of strategically located energy stations in a common metropolitan area. At these energy stations, vehicle customers can exchange a drained battery with a charged battery from the energy station. An energy station attendant can aid the customer in exchanging the batteries, for a nominal fee, which in some instances can be lower or equivalent to the fees charged for petroleum fuels.

One of the key enabling technologies which makes the present invention possible is a removable battery.

It is an advantage of the present invention to provide an electric vehicle power distribution network.

It is a further advantage of the present invention to provide an electric vehicle power distribution network for electric vehicles, whether two-wheel or four-wheel.

It is a further advantage of the present invention to provide an electric vehicle power distribution network which provides optimum means of energy purchase and battery capital costs.

The above noted and other advantages of the present invention will be better understood as the invention is revealed in the accompanying drawing and detailed description.

### BRIEF DESCRIPTION OF THE DRAWINGS

FIG. 1 is a schematic view of a preferred embodiment electric vehicle power distribution network according to the present invention.

### DETAILED DESCRIPTION OF THE INVENTION

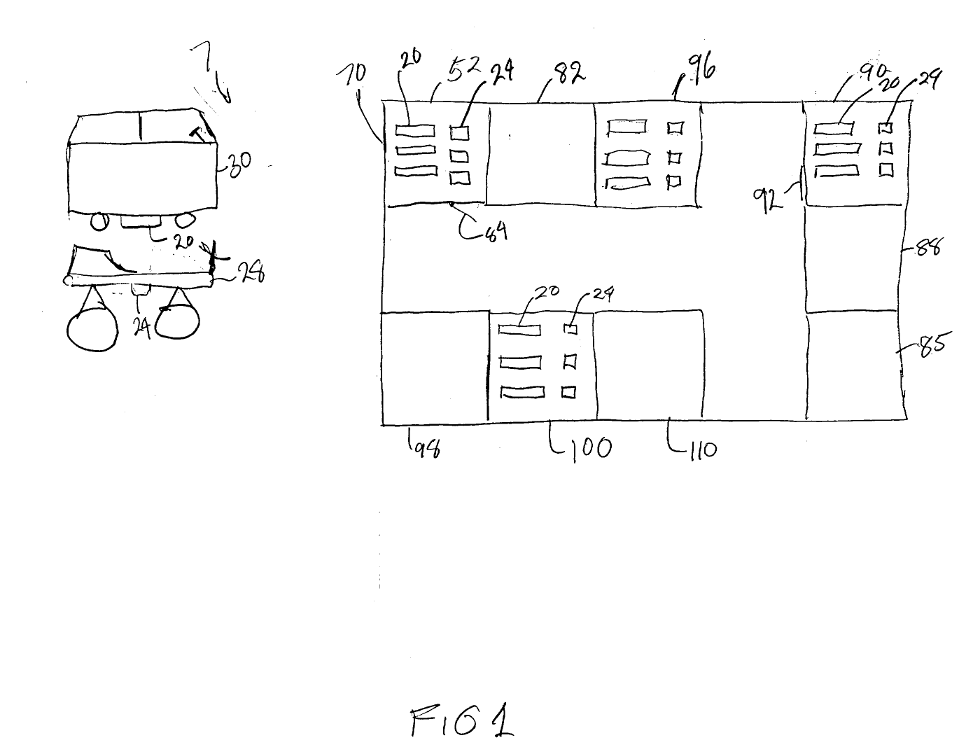

Referring to FIG. 1, an electric vehicle power distribution network 7 is shown, with only one energy station 70. In the complete energy distribution network 7 there will be a plurality or network of energy stations 70 strategically located throughout a metropolitan area and/or strategically located adjacent interstate arteries of a local region or state.

Each energy station will have a supply 52 of charged batteries 20,24. Batteries 20 will be for larger vehicles such as cars and/or light trucks. Batteries 24 will be for lighter vehicles such as motor scooters and electric bikes 28. Each power station will have a monetary exchange system 82. The monetary exchange system 82 in many instances, will be a retail sales person having facilities to accept cash or credit purchases by the customer. Additionally, the monetary exchange system 82 may be a self-serve type facility having monetary exchange machines capable of accepting cash, credit card or other electronic transfer payment arrangements, such as debit cards or pass key-type automatic billing.

When self-service is desired, payment by the customer will cause a locker door 84 to be released to allow the customer to open the locker door and to take the battery.

The energy station 70 also has a battery installation area 85. The battery installation area 85 provides a locale wherein the batteries 20, 24 may be installed quickly in their respective vehicles 28, 30. The battery installation area 85 may have room to accommodate the do-it-yourself customer or room for an installer, which provides the customer with a premium level of service. The battery installation area typically will be coterminous with the battery removal area 88.

The battery removal area 88 is next to an uncharged battery storage area 90. With premium service, the battery remover and installer will take the battery to the battery storage area 90. A one-way or securing gate or tray 92 can be utilized to allow the do-it-yourself customer to deposit their depleted charge battery so as to insure credit for the same.

The energy station 70 can also be supplied with a recharging station 96 to allow the batteries 20, 24 to be recharged onsite if so desired. A testing station 98 can test customers' batteries 20, 24 to determine the amount of charge remaining and if a new battery is required. Additionally, tests can be performed on the batteries 20, 24 to determine their capability of retention of charge or other maintenance tests. Again, these tests may be performed by an attendant or may be payment-automated to allow a customer to perform on their own.

The energy station 70 also has an area 100 which can sell or lease new batteries 20, 24, or replace batteries which have failed under warranty.

The energy distribution network 7 provides a plurality of operating and capital financing arrangements. In an ordinary arrangement, the operator of the electric vehicle 30 can make a simple purchase of a charged battery 20 and leave their depleted battery. The monetary charge for the new battery may be a standard flat rate or based upon the depletion of the exchanged battery.

Additionally, options may be further had in providing different amp hours of charge for different batteries or for different amounts of charges on a given battery depending upon the desire of the vehicle operator. To encourage electric vehicle utilization, the price of the recharged batteries can be made initially up front, when the vehicle is purchased.

In other arrangements, an entity who may own an interest in the energy station 70, an entity who may own an interest in the vehicle manufacturer or other private or non-private entities may have interest in the energy station or have interest in the vehicle battery.

In yet another arrangement, the vehicle operator will simply have their electric bill charged to pay for the newly charged battery.

Governmental bodies may seek to subsidize in whole or in part the capital cost associated with the vehicle batteries and/or the charging expense, to encourage electric vehicle use.

Furthermore, the energy station 70 can have another area 110 for vehicle maintenance and other related activity.

While a preferred embodiment of the present invention has been disclosed, it will be apparent to those skilled in the art of the various modifications that can be made without departing from the spirit and scope of the invention as it is encompassed by the following claims.

1. An electric vehicle power distribution network, comprising:
a plurality of energy stations, each said station having a supply of charged batteries;
a monetary exchange mechanism to allow a customer to purchase a charged battery for their electric powered vehicle;
a battery installation facility to allow for installation of said charged batteries into said customer's vehicle; and
a battery storage area to receive a depleted charge battery from said customer.

2. An electric vehicle power distribution network as described in claim 1, further including a plurality of said energy stations in a common metropolitan area.

3. An electric vehicle power distribution network as described in claim 1, wherein said energy station has facilities onsite for charging batteries.

4. An electric vehicle power distribution network as described in claim 3, wherein said energy station can sell a new battery.

5. An electric vehicle power distribution network as described in claim 1, wherein said energy station can sell a new battery.

6. An electric vehicle power distribution network as described in claim 1, wherein a customer may self-service their vehicle.

7. An electric vehicle power distribution network as described in claim 1, having premium service with an attendant to remove a customer's depleted charged battery and install a charged battery into said customer's vehicle.

8. An electric vehicle power distribution network as described in claim 1, for electric vehicles having four or more wheels.

9. An electric vehicle power distribution network as described in claim 1, for two-wheel electric vehicles.

10. An electric vehicle power distribution network as described in claim 1, wherein said energy station also sells repair services.

11. An electric vehicle power distribution network as described in claim 1, wherein the monetary exchange for said charged battery is dependent upon the charged state of said customer's battery.

12. An electric vehicle power distribution network as described in claim 1, wherein said monetary exchange mechanism includes charging said customer's electric bill for said charge.

13. An electric vehicle power distribution network as described in claim 1, wherein said customer purchases charged batteries at a point of purchase of said electric vehicle.

14. An electric vehicle power distribution network as described in claim 1, wherein the entity having ownership interest in said energy station has an ownership in said battery.

15. An electric vehicle power distribution network as described in claim 1, wherein a party not owning said vehicle has an ownership interest in said vehicle battery.
